(19) United States
(12) Patent Application Publication
(10) Pub. No.: US 2010/0203346 A1
(43) Pub. Date: Aug. 12, 2010

(54) TRANSPARENT OR TRANSLUCENT EXTRUDED POLYAMIDE

(75) Inventors: Elizabeth E. Grimes, Souderton, PA (US); William Todd Rogers, Collegeville, PA (US); Claire Michalowicz, Evreux (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema Inc., Philadelphia, PA (US)

(21) Appl. No.: 12/669,529

(22) PCT Filed: Jun. 26, 2008
(86) PCT No.: PCT/US08/68260

§ 371 Date: Jan. 18, 2010

Related U.S. Application Data
(60) Provisional application No. 60/951,787, filed on Jul. 25, 2007.

(51) Int. Cl. B32B 27/34; C08G 69/08; C08L 77/00; C08L 33/04; C08L 23/06; C08L 69/00; C08L 9/02; C08L 23/12; C08L 25/06

(52) U.S. Cl. 428/474.4; 528/310; 525/420; 525/183; 525/184; 525/433; 525/178; 524/606

(57) ABSTRACT

The invention relates to extruded transparent or translucent article that have been melt calendered to improve the physical properties and optical clarity. The polyamide article is a sheet, film, or profile.

### FIELD OF THE INVENTION

The invention relates to extruded transparent or translucent article that has been melt calendered to improve the physical properties and optical clarity. The polyamide article is a sheet, film, or profile.

### BACKGROUND OF THE INVENTION

Clear transparent sheets found in flat or thermoformed glazing applications are limited to polymethyl methacrylate homopolymers and copolymer (PMMA), polycarbonate (PC), polyesters and glycol modified polyesters (PETG), and in some instances polystyrene (PS). All of these products have performance deficiencies in some area. Clear transparent polyamide provides better properties or a better balance of properties not found in any of these other polymers. Polyamides have higher drop dart and drop ball impact strength then PMMA and PS, comparable impact strength to PC and PETG, and higher chemical resistance to chemicals used in applications where glazing must be sanitized on a daily basis, such as the pharmaceutical, medical and food industries.

Amorphous transparent polyamides are especially useful due to their excellent chemical, thermal, and abrasive resistance. These transparent amorphous polyamides are used to form molded or extrusion molded objects, as described in U.S. Pat. No. 6,277,911 (cycloaliphatic diamines with aliphatic dicarboxylic acids); extrusion molded alicyclic polyamide films (US 2007/0148482) for use on molded polyamides; and thin-walled injection molded articles, as described in U.S. Pat. No. 6,407,182 blends of transparent polyamides with a graft copolymer of branched polyamine and polyamide-forming monomers for extrusion molding.

Transparent polyamide films have been produced using a polyamide formed from an aliphatic-diamine/aliphatic diacid blended with nanocomposites using phyllosilicates through the use of extrusion processes, as described in US 2005/0215690.

Several references list the processing of clear transparent polyamides by customary thermoplastic processes, such as injection molding or extrusion (i.e. U.S. Pat. No. 5,360,891, and US 2005/0272908). While extrusion as a general process is mentioned, only injection molding is ever exemplified. Injection molding is a useful process for small parts—such as the lenses, baby bottles, etc described in the art, however injection molding is not economically viable as a means for producing large quantities of sheet, film or profiles. However, the sizes and thicknesses of transparent or translucent polyamide required to meet many of the applications involved in transparent glazing and other end uses can not be produced by injection molding.

One problem with extruded transparent polyamide structures is that “chatter” is created by the extrusion process, creating visible imperfections in the extruded object and thereby decreasing optical clarity.

It has now been found that transparent amorphous polyamide extruded into films, sheets and profiles, then followed by melt calendaring, provides structures of high optical quality. In addition to improving the optical quality, the melt calendering process also produces a more polished finish, lowers stress which reduces cracking and crazing, and produces a sheet or film having a lower level of shrinkage and a fine surface finish for transparent applications

### DETAILED DESCRIPTION OF THE INVENTION

The invention relates to extruded transparent or translucent polyamide sheet, film, or profiles that are melt calendered to improve the physical properties and optical clarity.

By “transparent”, as used herein is defined by light transmission per ASTM D1003 using an Illuminate C light source, as having a light transmission of greater than 85 percent, and preferably greater than 86 percent. The Haze, also defined by ASTM D 1003 will be less than 6 percent, and preferably less than 4 percent.

By “translucent” as used herein is meant any light transmission of greater tha 1 percent, and preferably greater than 2 percent as per ASTM D1003 using an illuminate C light source.

Transparent and translucent polyamides of the invention include those formed from the condensation of diamines with dicarboxylic acids or lactams. Such polyamides include those described in US 2004/0166342, incorporated herein by reference.

Useful diamines include, but are not limited to branched or linear aliphatic diamines having from 6 to 14 carbon atoms, e.g. 1,6-hexamethylenediamine, 2-methyl-1,5-diaminopentane, 2,2,4- or 2,4,4-trimethylhexamethylenediamine, 1,9-nonamethylenediamine, 1,10-decamethylenediamine, or 1,12-dodecamethylenediamine; cycloaliphatic diamines having from 6 to 22 carbon atoms, e.g. 4,4′-diaminodicyclohexylmethane, 3,3′-dimethyl-4,4′-diaminodicyclohexylmethane, 4,4′-di-aminodicyclohexylpropane, 1,4-diaminocyclohexane, 1,4-bis(aminomethyl)cyclohexane, 2,6-bis(aminomethyl)norbornane, or 3-aminomethyl-3,5,5-trimethylcyclohexylamine; and arylaliphatic diamines having from 8 to 22 carbon atoms, e.g. m- or p-xylylenediamine or bis(4-aminophenyl)propane; 4,4′-methylene-bis(cyclohexylamine or p-bis(aminocyclohexyl)methane (PACM), including those with 35 mol. percent or greater trans-trans linkages, and preferably those with less than 35 mol percent trans-trans linkages, including PACM 20 with 17 to 24 percent and PACM 10, 12, and 14; 2,2′-dimethyl-4,4′-methylenebis(cyclohexylamine) or bis (3-methyl-4-aminoclohexyl)methane (BMACM); bis(3,5-dialkyl-4-aminocyclohexyl)methane, -ethane, -propane or -butane.

Useful dicarboxylic acids include, but are not limited to branched or linear aliphatic dicarboxylic acids having from 6 to 22 carbon atoms, e.g. adipic acid, 2,2,4- or 2,4,4-trimethyladipic acid, azelaic acid, sebacic acid, or 1,12-dodecanedioic acid; cycloaliphatic dicarboxylic acids having from 6 to 22 carbon atoms, e.g. cyclohexane-1,4-dicarboxylic acid, 4,4′-dicarboxydicyclohexylmethane-, 3,3′-dimethyl-4,4′-dicarboxydicyclohexylmethane, 4,4′-dicarboxydicyclohe-xylpropane, and 1,4-bis(carboxymethyl)cyclohexane; arylaliphatic dicarboxylic acids having from 8 to 22 carbon atoms, e.g. 4,4′-diphenylmethanedicarboxylic acid; and aromatic dicarboxylic acids having from 8 to 22 carbon atoms, e.g. isophthalic acid, tributylisophthalic acid, terephthalic acid, 1,4-, 1,5-, 2,6- or 2,7-naphthalenedicarboxylic acid, diphenic acid, diphenyl ether-4,4′-dicarboxylic acid or 1,14-tetradecanedioic acid.

Useful lactams include, but are not limited to those having from 6 to 12 carbon atoms and the corresponding .omega.-aminocarboxylic acids, e.g. .epsilon.-caprolactam, .epsilon.-aminocaproic acid, capryllactam, omega.-aminocaprylic acid, omega.-aminoundecanoic acid, laurolactam, or .omega.-aminododecanoic acid.

Especially preferred monomers are those having cycloaliphatic chemistry, including but not limited to 4,4′-diaminodicyclohexylmethane, 3,3′-dimethyl-4,4′-diaminodicyclohexylmethane, 4,4′-di-aminodicyclohexylpropane, 1,4-diaminocyclohexane.

In one embodiment, the polyamide is formed by the condensation of at least one diamine selected from aromatic, arylaliphatic and cycloaliphatic diamines with a C₈₋₁₆ dicarboxylic acid. In a preferred embodiment, the dicaroxylic acid includes dodecanedioic acid and/or tetradecandioic acid, or a mixture containing at least 50 mol percent of tetradecanedioic and/or dodecanedioic acid and at least one diacid chosen from aliphatic, aromatic and cycloaliphatic dicarboxylic acids. Tetradecandioic acid, and mixtures of dicarboxylic acids with tetradecancioic acid containing at least 50 mole percent of tetradecandioic acid are particularly preferred—with the remaining dicarboxylic acids selected from C₉₋₁₈ aliphatic, isophthalic acid, terephthalic acid, naphthalene dicarboxylic acid, and cycloaliphatic dicarboxylic acids.

Other examples of transparent or translucent polyamides which may be used in invention include: the polyamide composed of terephthalic acid and of the isomer mixture composed of 2,2,4- and 2,4,4-trimethylhexamethylenediamine; the polyamide composed of isophthalic acid and of 1,6-hexamethylenediamine; the copolyamide composed of a mixture composed of terephthalic acid/isophthalic acid and of 1,6-hexamethylenediamine; the copolyamide composed of isophthalic acid, of 3,3′-dimethyl-4,4′-diaminodicyclohexylmethane, and of laurolactam or caprolactam; the (co)polyamide composed of 1,12-dodecanedioic acid or 1,10-decanedioic acid, of 3,3′-dimethyl-4,4′-diaminodicyclohexylmethane, and, where appropriate, of laurolactam or caprolactam; the copolyamide composed of isophthalic acid, 4,4′-diaminodicyclohexylmethane, and of laurolactam or caprolactam; the polyamide composed of 1,12-dodecanedioic acid and of 4,4′-diaminodicyclohexylmethane; the copolyamide composed of a terephthalic acid/isophthalic acid mixture, of 3,3′-dimethyl-4,4′-diaminodicyclohexylmethane and of laurolactam; the polyamide of 2,2′-dimethyl-4,4′-methylenebis(cyclohexylamine), 3,3′-dimethyl-4,4′-diamino-dicyclohexylmethane (BMACM), and linear dicarboxylic acids having from 8 (suberic acid) to 14 (1,14 tetradecanedioic acid) carbon atoms; mixtures of linear dicarboxylic acids and 35-60 mol % of trans,trans-bis-(4aminocyclohexyl)-methane (PACM) and 65-40% of an other diamine chosen from aliphatic, cycloaliphatic, arylaliphatic or aromatic diamines. Useful transparent polyamides in the invention, include those taught in U.S. patent application Ser. No. 11/127,623, incorporated herein by reference.

For the purposes of the invention, the transparent or translucent polyamide may a blend or alloy of two or more different polyamides. One or more components of the blend may also be crystalline, though amorphous components are preferred. The key factor is the blend must be transparent or translucent.

In another embodiment, the polyamide of the invention is blended with another transparent or translucent thermoplastic material to produce an extrudable, compatible blend. The blend percentages could range from 5 to 95% polyamide, preferably over 50 percent by weight of the polyamide of the invention. Translucent or transparent thermoplastics useful for blending with the polyamide of the invention include, but are not limited to, polymethylmethacrylates, polycarbonates, polystyrene, polyvinylidene fluoride and its copolymers, and polyesters such as polyethylene terephthalate, polybutylene terephalate, and polyethylene terephthalate—glycol modified. In one embodiment, the polyamide blend aids in adhesion of the polyamide to other substrates, and the polyamide blend may be directly co extruded onto various substrates without the need for a tie layer or adhesive.

The polyamides of the invention may be made of any conventional process for the synthesis of polyamides and copolyamides by condensation of the corresponding monomers. The synthesis can be carried out in the presence of a catalyst. This is advantageously an organic or inorganic catalyst and this is preferably phosphoric acid or hypophosphoric acid. The amount of catalyst can be up to 3000 ppm with respect to the weight of the amorphous polyamide and advantageously between 50 and 1000 ppm.

The transparent or translucent polyamide of the invention may be blended with additives, prior to extrusion. Examples of useful additives include, but are not limited to, optical brighteners, UV absorbers, UV stabilizers, pigments, dyes, reinforcing or non-reinforcing fillers, heat stabilizers, internal or external lubricants, plasticizers, flame retardants, conductive or static-dissipative fillers, impact modifiers or chain-termination agents.

In addition to extrusion of a monolithic transparent or translucent polyamide sheet, polyamides can be coextruded with other thermoplastics to form multi-layer structures. By coextrusion is meant two or more different layers extruded in contact with each other. In one embodiment, the polyamide could be coextruded as a thin outer layer over other thermoplastics to provide a high level of abrasion resistance and chemical resistance. Useful other thermoplastics for coextrusion include, but are not limited to polymethacrylates; polycarbonates; polystyrene and high impact polystryrene (HIPS); polysuiphones amorphous polyesters; polyolefins such as polyethylene (PE), polypropylene and blends thereof; thermoplastic polyolefins (TPO), polyvinyl chloride (PVC), acrylonitrile-butadiene-styrene (ABS), and polycarbonate/ABS blends. The transparent or translucent polyamide cap stock could be coextruded onto one or both sides of the other thermoplastic. Coextruded cap over certain polymers can also be opaque, which would be transmitting no light per ASTM D-1003 illuminate “C” or any other light for that matter. The other thermoplastic could be transparent, translucent or opaque.

In another embodiment, a transparent or translucent polyamide could be coextruded over another polyamide layer having the same or a different chemistry, the the coextruded top layer containing a special additive, such as a different dye or pigment (for a multi-color effect), or containing a UV absorber or other special additive.

Because of the high impact strength of many polyamides, they could coextruded onto other glazing material to improve impact, chemical and abrasion resistance. Uses for this type of coextruded sheet would be in areas where protection, such as against severe weather or vandalism such as burglary and graphitti is required. This includes, but is not limited to vertical or sloped glazing, roof panel, skylights and other glazing where security is required. Coextruded sheet may also have applications where lamination is currently used in security applications such as blast and bullet resistance. Another use for the extruded, calendered sheet or film of the invention is in sanitaryware applications such as bathtubs and spas and in automotive applications, such as bumpers, wheel cover trim and other functional and decorative assemblies thermoformed from melt calendared coextruded sheet products.

In a typical continuous extrusion and melt calendaring process, polyamide resin of the invention is conveyed, typically by an air conveyer, to a desiccated hot air bed drier and dried at about 80° C. for about 4-12 hours in a vacuum oven. The dried resin is conveyed and fed via metering equipment to the feed section of an extruder. The extruder may be of the single screw type, double screw type, or other arrangement. In the extruder, the polyamide resin is melted by heat provided from electrical heater bands, by pressure and by shear within the operating extruder. The resulting polymer melt is conveyed through the extruder by a screw, the speed (rpm) of which can be varied to adjust output rate necessary for accommodating different sheet, film or profile thicknesses. During extrusion, residual volatiles (such as moisture and remaining residual monomer) from the polymer are vented off using a water sealed vacuum pump. Effective temperatures of extrusion are in the range of 520-570° F. A preferred temperature range is 540-550 F. The calendaring roll temp in one process was 230-260° F., and preferably 245-250° F. The molten polymer exiting the front end of the extruder is forced under pressure to provide an even flow into a sheet slot die heated at 215-245° C. (preferably from 520-550° F.) The sheet slot die has variable thickness and width control and thermal control. The molten polymer is uniformly distributed across the width of the die. Molten polymer uniformly exits the sheet slot die and is immediately melt calendered on two or more heated, highly polished steel or chrome-plated steel calendering rolls retained in a calendering roll stand. The sheet is gauged and polished as it progresses along the calendering rolls. The temperature of the calendering rolls is within the range of from about 85° C. to about 100° C. The calendaring roll temperature being in the range of 230-260° F. The sheet is then pulled over a series of idler rollers on which the sheet cools. At the end of the line, protective sheet masking is applied, if desired, and the sheet is cut into its final dimensions and stacked.

Co-extruded sheet, film or profiles may be produced by a co-extrusion process comprised of two or more extruders converting plastic resin materials into molten plastic. Typically, there is a minimum of a primary extruder and a secondary extruder, but there may also be additional extruders, such as a tertiary extruder, etc. The primary extruder is usually the largest extruder and has the highest throughput rate compared to the other individual extruder(s). Therefore, for example, in a 2-layer sheet configuration, the resin used to comprise the substrate layer is typically fed into the primary extruder and the cap layer resin is typically fed into the secondary extruder when using a co-extrusion set-up consisting of 2 extruders. Either the substrate layer, the cap layer or both can be polyamide or a blend of polyamide and another polymer such as PMMA, PC, ABS, PS, PETG, ABS/PC blend, Polyolefin's (TPO's, PP, PE), etc. Each of these extruders converts the resins fed to them into molten polymer, separately. The melt streams are then combined typically in a feedblock system or in a multi-manifold die set-up. In the feedblock system, there is a plug that is installed that determines how these 2 molten plastics will be layered in the final sheet. Hence, the polymer melt streams enter into the feedblock separately and are selectively combined within the feedblock. For a coextrusion producing a multilayer sheet configuration of 3 layers or greater, the polyamide layer may be located in any of the layers or in layers blended with, but no limited to PMMA, PC, ABS, PS, PETG, ABS/PC blend, Polyolefin's (TPO's, PP, PE) and polyamide poly ether multi block copolymers to improve adhesion. Once the plastic melt streams are selectively layered and co-mingled in the feedblock, the combined melt stream exits the feedblock and enters the die where the combined melt stream is spread to the width of the die. The molten plastic extrudate is then polished between highly polished chrome-plated, temperature-controlledcalendering rolls. These rolls polish and cool the sheet to the desired overall thickness. Note that a multi-manifold die may also be used to achieve a layered sheet instead of a feedblock system. The polymer melt streams enter into the multi-manifold die separately and are selectively combined and spread to the width of the die all within the multi-manifold die.

The transparent or translucent calendered amorphous polyamide film, sheet or profiles can be made in thicknesses ranging from 0.003 inch thick film up to 0.500 inch thick sheet.

The polyamide films, sheet or profiles made by the extrusion and melt calendering have excellent optical quality (for transparent polyamides), chemical resistance, abrasion resistance, high impact strength, weatherability, a polished finish, and a low level of shrinkage. Additionally the extruded, calendared polyamide-containing film, sheet or profile has low stress—which reduces cracking and crazing. Applications for the sheet, films and profiles are those that would benefit from these properties or combinations of these properties.

These properties make them useful in many, varied applications. The combination of ductility, impact resistance and abrasion resistant suitable for the Nascar glazing, motorcycle windscreen and bullet and blast resistance clear laminated glazing markets and applications where glazing with a high chemical resistance is required, such as but not limited to, machine guards and glazing in food or pharmacuetical industry or in hospital applications where sterlization is needed like incubators and other transparent glazing that needs to be sanitized on a regular basis. Clear polyamides may have higher abrasion resistance in these applications and may not require an abrasion resistant hardcoat. Polyamides may be used in formed applications where abrasion resistance is required.

In outdoor applications where weatherability is essential, high impact polymers, such as PC and PETG will not withstand outdoor exposure without a special coating or cap layer applied to the exposured surface. Clear transparent polyamides will exceed the weatherability of PC, PETG and PS, and also provide abrasion resistance.

Polyamide at 1.3 mm has been tested for drop dart impact at 14 ft-lbs without breakage, making the extruded, calendered polyamide useful in security glazing applications where bullet, blast or burglary resistance is required. The polyamide can be used either as a sheet by itself, or as a layer in a multi-layer glazing.

Clear transparent polyamide sheet can be used in flat and thermoformed glazing applications where current clear transparent polymers have deficiencies in chemical, impact and abrasion resistance. These applications include high impact and chemically resistant machince guards in the food, medical and pharmaceutical industry and high impact on and off road vehicle (automotive, motorcycle, campers, trailers), transit (rail, bus and subway cars), skylight, roof panel, and security glazing.

Other applications could include point of purchase displays where high impact to reduce in-use breakage and chemical resistance is required.

What is claimed is:

1. A transparent or translucent article comprising at least one layer comprising one or more amorphous transparent or translucent polyamides in the form of a sheet, film or profile wherein said article is formed by an extrusion process followed by melt calendaring.

2. The article of claim 1, wherein said article is a film, sheet or profile.

3. The article of claim 1, wherein said article comprises more than one layer, with at least one layer being a transparent or translucent polyamide

4. The article of claim 1, wherein said article is transparent.

5. The article of claim 1 wherein said polyamide is formed by the condensation of at least one diamine selected from aromatic, arylaliphatic and cycloaliphatic diamines with a C₈₋₁₆ dicarboxylic acid.

6. The article of claim 5, wherein said C₈₋₁₆ dicarboxylic acid comprises a linear aliphatic diacid.

7. The article of claim 6, wherein said dicarboxylic acid comprises dodecanedioic acid and/or tetradecanedioic acid.

8. The article of claim 7, wherein said dicarboxylic acid is tetradecanedioic acid, or a mixture containing at least 50 mole percent of tetradecanedioic acid with at least one other dicarboxylic acid.

9. The article of claim 1, comprising a polyamide formed by the condensation of a mixture comprising at least one cycloaliphatic diamine and tetradecanedioic acid.

10. The article of claim 5, wherein said cycloaliphatic diamine comprises 3,3′-dimethyl-4,4′-diaminodicyclohexylmethane (BMACM) and/or 4,4′-diaminodicyclohexylmethane (PACM).

11. The article of claim 1, wherein said polyamide is blended with one or more other thermoplastics prior to extrusion.

12. The article of claim 11, wherein said one or more other thermoplastics are selected from the group consisting of polymethacrylates; polycarbonates; polystyrene and high impact polystryrene (HIPS); polysulphones amorphous polyesters; polyolefins such as polyethylene (PE), polypropylene and blends thereof; thermoplastic polyolefins (TPO), polyvinyl chloride (PVC), acrylonitrile-butadiene-styrene (ABS), and polycarbonate/ABS blends.

13. The article of claim 1, wherein said article comprises a multi-layer article comprising at least one layer of a transparent or translucent polyamide, and at least one layer of a different thermoplastic.

14. The article of claim 1, wherein said article further comprises at least on additive selected from the group consisting of optical brighteners, UV absorbers, UV stabilizers, pigments, dyes, reinforcing or non-reinforcing fillers, heat stabilizers, internal or external lubricants, plasticizers, flame retardants, conductive or static-dissipative fillers, impact modifiers, and chain-termination agents

15. The article of claim 1 comprising a glazing.

16. The article of claim 115, wherein said glazing is selected from the group consisting of on and off road vehicle glazing, automotive glazing, motorcycle glazing, camper glazing, trailer glazing, railcar glazing, bus glazing, subway glazing, skylights, roof panels, laminated or monolithic security glazing, machine guards and point of purchase displays.

17. The article of claim 16, wherein said machine guards comprise medical, pharmaceutical, and chemical applications.

18. The article of claim 1, wherein said article is a film.

19. The article of claim 18, wherein said film comprises a packaging material, or a liner for chemical or bio-pharmaceutical reactors.
